(19) United States
(12) Patent Application Publication
(10) Pub. No.: US 2012/0116596 A1
(43) Pub. Date: May 10, 2012

(54) MASS FLOW CONTROLLER

(75) Inventors: Yutaka Yoneda, Kyoto-shi (JP); Yuki Tanaka, Kyoto-shi (JP)

(73) Assignee: HORIBA STEC, Co., Ltd., Kyoto-shi (JP)

(21) Appl. No.: 13/290,984

(22) Filed: Nov. 7, 2011

(30) Foreign Application Priority Data
Nov. 8, 2010 (JP) 2010-250208

(51) Int. Cl. G05D 7/00

(52) U.S. Cl. 700/282

(57) ABSTRACT

The present invention comprises a flow rate sensor part and control valve; a calculation part that performs a proportional calculation on a deviation between a flow rate measurement value and setting value to calculate a feedback control value for the flow rate control valve; and an opening level control signal output part that generates an opening level control signal on the basis of the feedback control value to output the opening level control signal to the flow rate control valve. A gain value to be multiplied by the deviation is calculated by using a function that, in a predetermined period after the time point when the flow rate setting value decreases by a predetermined amount or more, calculates a larger value as a calculation value obtained by using a variation between the flow rate setting value before the decrease and a flow rate setting value after the decrease decreases.

### TECHNICAL FIELD

The present invention relates to a mass flow controller that controls a flow rate of fluid such as gas or liquid.

### BACKGROUND ART

For example, in the case of supplying various gases and the like used for semiconductor manufacturing to a semiconductor manufacturing apparatus, flow paths for supplying them are respectively provided with mass flow controllers, and the mass flow controllers respectively adjust flow rates of the gases.

As a flow rate control method in the mass flow controller, a PID control is the base; however, for example, as disclosed in Patent literature 1, a method adapted to perform feedback control obtained by providing a variation to the PID control is also known. A method specifically disclosed in Patent literature 1 is one that is adapted to calculate a feedback control value by performing a PID calculation on a deviation, and then multiplying a result of the calculation by a function of which a value is increased as a flow rate setting value decreases.

This control method enables optimum control to be performed; however, to pursue control with higher accuracy, problems may occur, as described below. That is, in a mass flow controller based on the control method disclosed in Patent literature 1, when the flow rate setting value is decreased from, for example, 100% to a desired flow rate setting value such as 2% (at the fall time), the following may occur. After the flow rate setting value has been changed at the fall time in this manner, as illustrated in FIG. 5, a valve applied voltage of a flow rate control valve of the mass flow controller, or an actual flow rate that is controlled by the mass flow controller may take a value that exceeds a target value. Also, by the valve applied voltage that exceeds the target value, extra force may be applied to the flow rate control valve to thereby accelerate deterioration of the valve.

### CITATION LIST

### Patent Literature

[Patent literature 1] JP 2004-280689A

### SUMMARY OF THE INVENTION

### Technical Problem

Therefore, the present invention is made to solve the above problems, and has a main desired object to enable a flow rate control valve of a mass flow controller to be used for a longer time, and also to provide a mass flow controller that can control an actual flow rate with higher accuracy when a flow rate setting value is decreased.

### Solution to Problem

Accordingly, a mass flow controller according to the present invention is provided with: a flow rate sensor part that measures a flow rate of fluid that flows through a flow path, and outputs a flow rate measurement signal that indicates a value of the measurement; a flow rate control valve that is provided on an upstream side or a downstream side of the flow rate sensor part; a calculation part that at least performs a proportional calculation on a deviation between the flow rate measurement value indicated by the flow rate measurement signal and a flow rate setting value that is a target value, and calculates a feedback control value for the flow rate control valve; and an opening level control signal output part that generates an opening level control signal on the basis of the feedback control value to output the opening level control signal to the flow rate control valve, wherein: as a gain value that is multiplied by the deviation in the proportional calculation, a value obtained by substituting the flow rate setting value into a predetermined function is used; and in a decrease change period that is a predetermined period after a time point when the flow rate setting value decreases by a predetermined amount or more, the predetermined function is a function that is substituted with a calculation value obtained by using a variation between the flow rate setting value before the decrease and a flow rate setting value after the decrease and calculates a larger value as the calculation value decreases.

If so, the gain value is calculated by using the function that calculates a larger value as the calculation value obtained by the variation between the flow rate setting value before the decrease and the flow rate setting value after the decrease decreases, and therefore in the decrease change period, an actual flow rate can be accurately controlled. Also, by using the above-described function, a valve applied voltage can be prevented from exceeding a target value in the decrease change period, and therefore extra force can be prevented from being applied to the flow rate control valve to thereby use the flow rate control valve for a longer time.

Preferably, in an increase change period that is a predetermined period after a time point when the flow rate setting value increases by a predetermined amount or more, the predetermined function used for the increase change period is a function that calculates a larger value as the flow rate setting value to be substituted decreases. If so, control is changed between the increase change period and the decrease change period, and therefore the flow rate control that is optimum for flow rate variation characteristics in the increase or decrease change period can be performed. Accordingly, in any of the increase and decrease change periods, the actual flow rate can be made to quickly follow the flow rate setting value after the change to thereby improve flow rate stability.

In this case, the increase or decrease change period may be constantly fixed, or in order to improve control stability, the duration may be varied depending on the situation. An example of this includes a case where the increase change period or the decrease change period are adapted to be ended at a time point when the deviation between the flow rate measurement value and the flow rate setting value falls within a certain range.

Also, a flow rate control program according to the present invention is used for a mass flow controller provided with: a flow rate sensor part that measures a flow rate of fluid that flows through a flow path, and outputs a flow rate measurement signal that indicates a value of the flow rate measurement; and a flow rate control valve that is provided on an upstream side or a downstream side of the flow rate sensor part, and provides a computer with functions as: a calculation part that at least performs a proportional operation on a deviation between the flow rate measurement value indicated by the flow rate measurement signal and a flow rate setting value that is a target value, and calculates a feedback control value for the flow rate control valve; and an opening level control signal output part that generates an opening level control signal on the basis of the feedback control value, and outputs the opening level control signal to the flow rate control valve, wherein as a gain value that is multiplied by the deviation in the proportional calculation, the calculation part uses a value obtained by substituting the flow rate setting value into a predetermined function; and in a decrease change period that is a predetermined period after a time point when the flow rate setting value was decreased by a predetermined amount or more, the predetermined function is a function that is substituted with a calculation value obtained by using a variation between the flow rate setting value before the decrease and a flow rate setting value after the decrease and calculates a larger value as the calculation value decreases.

### Advantageous Effects of Invention

According to the present invention configured as described, a flow rate control valve of a mass flow controller can be used for a longer time, and also a mass flow controller that can control an actual flow rate with higher accuracy when a flow rate setting value is decreased can be provided.

### BRIEF DESCRIPTION OF THE DRAWINGS

FIG. 1 is a schematic configuration diagram of a flow rate measurement system according to one embodiment of the present invention;

FIG. 2 is a configuration example of a flow rate control system using a mass flow controller according to the same embodiment;

FIG. 3 is a functional block diagram of a control part in the same embodiment;

FIG. 4 is a control flowchart in the same embodiment; and

FIG. 5 is a schematic diagram illustrating variations of a valve applied voltage and an actual flow rate at the fall time in a conventional example.

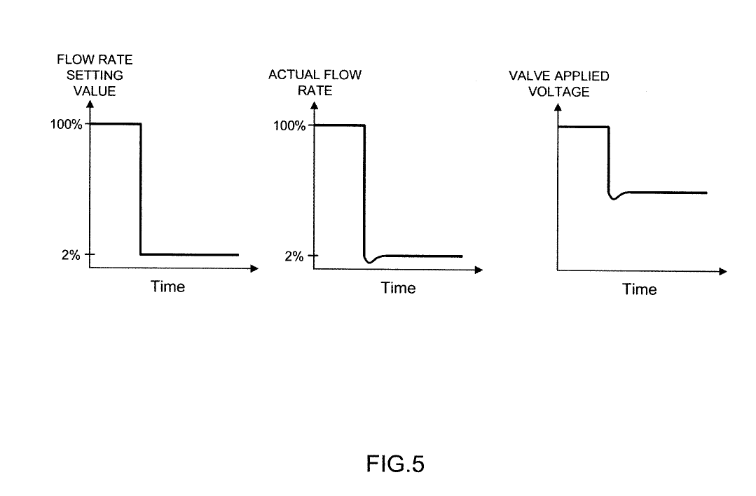

### DETAILED DESCRIPTION OF THE EMBODIMENTS

In the following, one embodiment of a flow rate measuring system according to the present invention is described referring to the drawings.

### <Device Configuration>

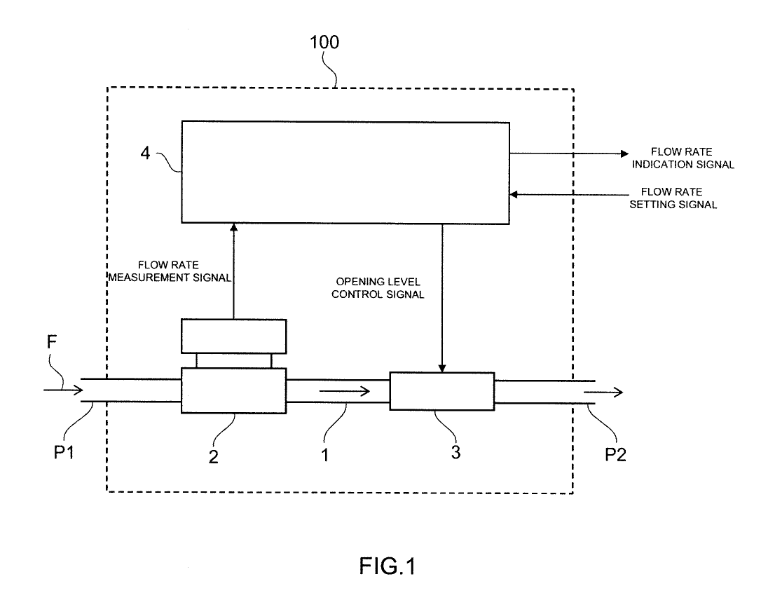

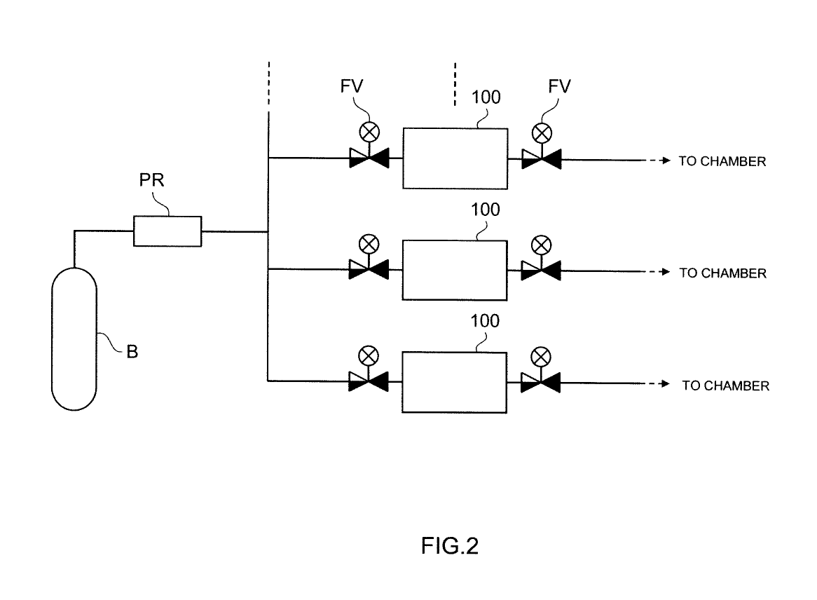

A mass flow controller 100 according to the present embodiment is, as illustrated in a schematic diagram of FIG. 1, an internal flow path 1, a flow rate sensor part 2 that measures a flow rate of fluid F that flows through the internal flow path 1, a flow rate control valve 3 that is provided, for example, on a downstream side of the flow rate sensor part 2, and a control part 4, and is, for example, as illustrated in FIG. 2, used in a system for supplying gas to chambers in a semiconductor process.

To describe each of the parts, the internal flow path 1 is one that is opened at an upstream end as an inlet port P1 and at a downstream end as an outlet port P2, respectively, and for example, the inlet port P1 and the outlet port P2 are respectively connected with a fluid supply source B such as a cylinder through an external pipe and a chamber (not illustrated) for semiconductor manufacturing through an external pipe. Note that this embodiment is adapted to, as illustrated in the same diagram, provide a branched pipe from the one fluid supply source B into a plurality of pipes, and provide each of the plurality of pipes with the mass flow controller 100. Also, a pressure regulator PR is provided only at an outlet of the fluid supply source B, and each of the pipes is not provided with a pressure regulator for the mass flow controller 100. In addition, a reference symbol FV represents a pneumatic valve.

The flow rate sensor part 2 is one that is provided with, although not illustrated in detail, for example, a pair of thermal sensors provided in the flow path 1, and adapted to detect an instantaneous flow rate of the fluid F with the thermal sensors as an electric signal, and perform amplification or the like of the electric signal with an internal electric circuit to output a value corresponding to a detected flow rate as a flow rate measurement signal.

The flow rate control valve 3 is one that is configured to, although not illustrated in detail as well, for example, enable a valve opening level thereof to be changed by an actuator including a piezo element, and is a valve that drives the actuator by being given an opening level control signal that is an external electric signal, and makes an adjustment to a valve opening level corresponding to a value of the opening level control signal to control a flow rate of the fluid F.

The control part 4 is one that is configured to have a digital or analog electric circuit having a CPU, a memory, an A/D converter, a D/A converter, and the like, and may be a dedicated one or one adapted to use a general-purpose computer such as a personal computer for part or all thereof. Alternatively, without using the CPU, the control part 4 may be configured to fulfill functions as the respective part only with an analog circuit, may not be physically integrated, or may be a plurality of devices that are mutually connected by wired or wireless connections.

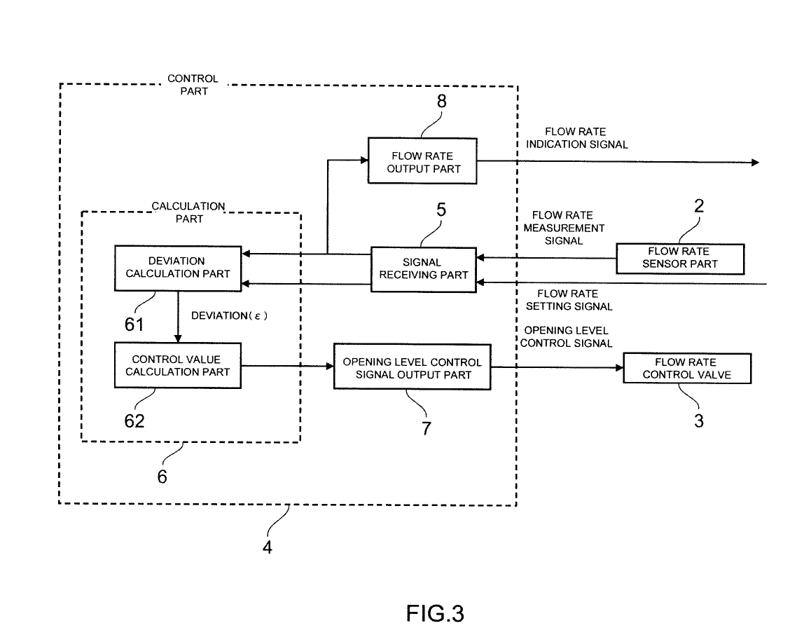

Also, the control part 4 is configured to, by storing a predetermined program in the memory, and cooperatively operating the CPU and its peripheral devices according to the program, as illustrated in FIG. 3, at least fulfill functions as a signal receiving part 5, a calculation part 6, an opening level control signal output part 7, and a flow rate output part 8.

The signal receiving part 5 is one that receives the flow rate measurement signal transmitted from the flow rate sensor part 2, and a flow rate setting signal or the like inputted from another computer or the like, and stores values of them in, for example, a predetermined area of the memory.

The calculation part 6 is one that is provided with: a deviation calculation part 61 that obtains a flow rate measurement value indicated by the flow rate measurement signal, and calculates a deviation between the flow rate measurement value and a target value, i.e., a flow rate setting value indicated by the flow rate setting signal; and a control value calculation part 62 that at least performs a proportional calculation (in the present embodiment, a PID calculation) on the deviation to calculate a feedback control value for the flow rate control valve 3.

The opening level control signal output part 7 is one that generates an opening level control signal having a value based on the feedback control value and outputs the opening level control signal to the flow rate control valve 3.

The flow rate output part 8 is one that performs a predetermined calculation on the flow rate measurement value to calculate a flow rate indication value and outputs a flow rate indication signal (analog or digital signal) having the flow rate indication value as a value in an externally utilizable manner.

Also, in this embodiment, the control value calculation part 62 is adapted to make a gain value to be multiplied by the deviation in the PID calculation different between an increase change period that is a fixed period (e.g., around 2 seconds) after a time point when the flow rate setting value increases by a predetermined amount or more and a decrease change period that is a fixed period (e.g., around 2 seconds) after a time point when the flow rate setting value decreases by a predetermined amount or more.

Specifically, the control value calculation part is adapted to use, as the gain value to be multiplied by the deviation in the PID calculation, a value obtained by substituting the flow rate setting value into a predetermined function, and to use mutually different functions as the function for the increase change period and the decrease change period, respectively. Further, the control value calculation part is adapted to make a function used in a stable period other than the increase and decrease change periods different from the functions for the increase and decrease change periods.

The function used in the increase change period (when distinguished, hereinafter also referred to as a first function) is one that calculates a larger value as the flow rate setting value to be substituted decreases, and expressed herein by, for example, the following expression (1):

f₁(S)=(100+a₁)/(a₁+S) (1)

Here, S represents a flow rate setting value (% value with respect to a full scale) after the increase, and a₁ represents an adjustment factor.

The function used in the decrease change period (when distinguished, hereinafter also referred to as a second function) is one that is substituted with a calculation value obtained by using a difference between the flow rate setting value before the decrease and a flow rate setting value after the decrease and calculates a larger value as the calculation value decreases, and expressed herein by, for example, the following expression (2):

f₂(Sₙ)=(100+a₂)/(a₂+Sₙ) (2)

Here, Sₙ=(S−Sₙ₋₁)×K+Sₙ₋₁, and a₂ represents an adjustment factor.

Also, S represents the flow rate setting value (% value with respect to a full scale) after the decrease, Sₙ represents a calculation value currently calculated, Sₙ₋₁ represents a calculation value previously calculated, and K represents an arbitrary factor.

The function used in the stable period (when distinguished, hereinafter also referred to as a third function) is one that calculates a smaller value as the flow rate setting value to be substituted decreases, and expressed herein by, for example, the following expression (3):

f₃(S)=S×a₃+D (3)

Here, a₃ represents an adjustment factor, and D represents an offset constant.

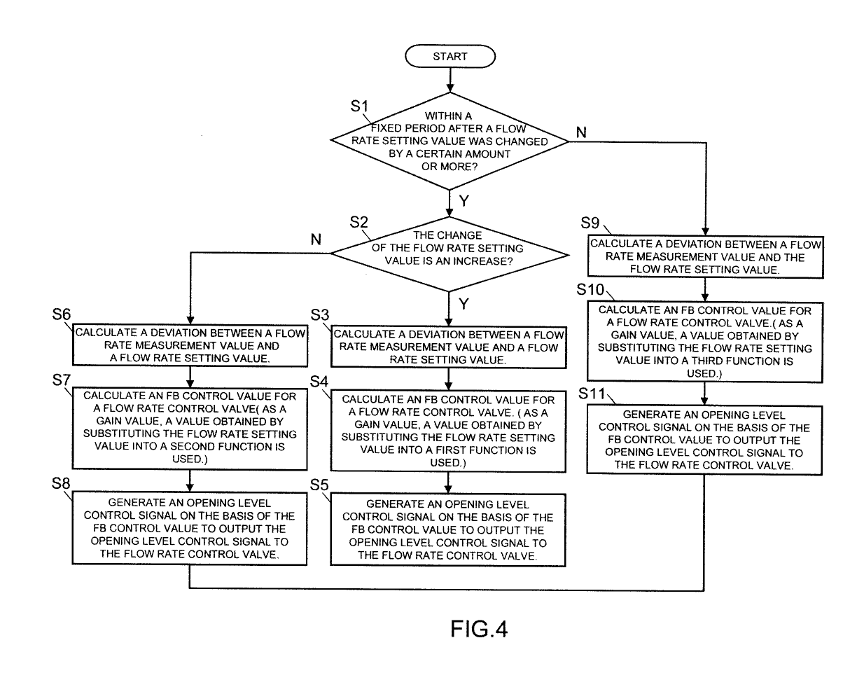

Next, actuation of the mass flow controller 100 having the above configuration is described referring to a flowchart in FIG. 4 with a focus on the control part 4.

The signal receiving part 5 receives the flow rate measurement signal that is constantly outputted from the flow rate sensor part 2 and the flow rate setting signal that is outputted from dedicated input means or another computer, and samples them at regular intervals (Step S1).

If the flow rate setting value is changed by a predetermined amount or more, the signal receiving part 5 determines that the fixed period (around 2 seconds) after a time point of the change is a change period, and the flow proceeds to Step S2, whereas if the flow rate setting value is not changed by a predetermined amount or more, the signal receiving part 5 determines that a period other than the change period is the stable period, and the flow proceeds to Step S9.

If the fixed period is determined to be the change period, it is further determined whether the change of the flow rate setting value by the predetermined amount or more is an increase or decrease, and if the change is an increase, the change period is determined to be the increase change period, and the flow proceeds to Step S3, whereas if the change is a decrease, the change period is determined to be the decrease change period, and the flow proceeds to Step S6.

If the change period is determined to be the increase change period, the deviation calculation part 61 calculates a difference between a value of the flow rate measurement signal (flow rate measurement value) that is received by the signal receiving part 5 and the flow rate setting value that is a value of the flow rate setting signal, i.e., a deviation ε (Step S3).

Then, the control value calculation part 62 performs the PID calculation on the deviation to calculate a feedback control value for the flow rate control valve 3. At this time, as the gain value to be multiplied by the deviation ε in the PID calculation, a value obtained by substituting the flow rate setting value into the first function is used (Step S4).

Subsequently, the opening level control signal output part 7 generates an opening level control signal on the basis of the feedback control value to output the opening level control signal to the flow rate control valve 3, and changes a valve opening level of the flow rate control valve 3 to adjust a flow rate (Step S5).

On the other hand, if the change period is determined to be the decrease change period, the deviation calculation part 61 calculates a difference between a value of the flow rate measurement signal (flow rate measurement value) that is received by the signal receiving part 5 and the flow rate setting value that is a value of the flow rate setting signal, i.e., a deviation ε (Step S6).

Then, the control value calculation part 62 performs the PID calculation on the deviation to calculate a feedback control value for the flow rate control valve 3. At this time, as the gain value to be multiplied by the deviation ε in the PID calculation, a value obtained by substituting the flow rate setting value into the second function is used (Step S7).

Subsequently, the opening level control signal output part 7 generates, as in Step S5, an opening level control signal on the basis of the feedback control value to output the opening level control signal to the flow rate control valve 3, and changes a valve opening level of the flow rate control valve 3 to adjust a flow rate (Step S8).

Also, if the change period is determined to be the stable period (e.g., the answer at 51 is no), the deviation calculation part 61 calculates a difference between a value of the flow rate measurement signal (flow rate measurement value) that is received by the signal receiving part 5 and the flow rate setting value that is a value of the flow rate setting signal, as in Step S3 or S6, i.e., a deviation ε (Step S9).

Then, the control value calculation part 62 performs the PID calculation on the deviation ε to calculate a feedback control value for the flow rate control valve 3. At this time, as the gain value to be multiplied by the deviation ε in the proportional calculation, a value obtained by substituting the flow rate setting value into the third function is used (Step S10).

After the feedback control value has been calculated in this manner, as in Step S5 or S8, the opening level control signal output part 7 generates an opening level control signal on the basis of the feedback control value to output the opening level control signal to the flow rate control valve 3, and changes a valve opening level of the flow rate control valve 3 to adjust a flow rate (Step S11).

### Effects of the Present Embodiment

According to the mass flow controller 100 of the present embodiment configured as described, the control is changed among the stable period, the increase change period, and the decrease change period, so that in each of the change periods during which the flow rate setting value is changed, an actual flow rate can be made to quickly follow a flow rate setting value after the change, and in the stable period during which the flow rate setting value hardly changes, even if a disturbance such as a variation in primary pressure (pressure on an upstream side of the mass flow controller 100) occurs, a hypersensitive reaction to the disturbance can be suppressed to stabilize the actual flow rate. Also, the control is changed between the increase period and the decrease change period, and therefore the flow rate control that is optimum for flow rate variation characteristics in the increase period or the decrease change period can be performed. Accordingly, in any of the increase and decrease change periods, the actual flow rate can be made to quickly follow the flow rate setting value after the change to thereby improve flow rate stability. In particular, according to the mass flow controller 100 of the present embodiment, the gain value is calculated by using a function that calculates a larger value as a calculation value obtained by using a variation between a flow rate setting value before a decrease and a flow rate setting value after the decrease decreases, and therefore, in the decrease change period, the actual flow rate can be controlled with higher accuracy. Also, by using the above function, the valve applied voltage can be prevented from exceeding a target value in the decrease change period, and therefore extra force can be prevented from being applied to the flow rate control valve to thereby use the flow rate control valve for a longer time.

### <Other Variations>

Note that the present invention is not limited to the above-described embodiment.

For example, each of the change periods is not required to be constantly fixed, but may be ended by some trigger other than a timer. Examples of this include the case where each of the change periods is ended when a deviation between a flow rate measurement value and a flow rate setting value falls within a certain range.

Also, even in the case where the increase and decrease change periods are respectively fixed, they are not necessarily the same but may be adapted to be different from each other.

Further, the functions used in the respective periods may be fixed ones that are not varied in the respective periods, or ones that are varied.

For example, a function (e.g., first function) used in each of the change periods may be configured to be varied with time in a gradual (stepwise or continuous) manner. In this case, if the first and second functions are adapted to have almost the same value when the change period is switched to the stable period, i.e., configured to have almost the same control factor (gain value) at the time of the change, an unstable factor for the control due to a variation in control factor at the time of the change can be eliminated.

In addition, regarding Sₙ that is to be substituted into the second function of the above-described embodiment, in addition to a calculation value obtained by Sₙ=(S−Sₙ₋₁)×K+Sₙ₋₁, a calculation value obtained by moving average may be substituted. In addition, the gain values for the increase and decrease change periods may be made different from each other by making the adjustment factors a₁ and a₂ of the first function and the second function different.

In addition, the control valve may be provided on an upstream side of the flow rate sensor part 2, and the flow rate sensor part 2 is not limited to the thermal sensor but may be one based on another flow rate measurement method, such as a differential pressure sensor.

It should be appreciated that the present invention is not limited to any of the above-described embodiments, but can be variously modified without departing from the scope thereof.

### REFERENCE CHARACTERS LIST

100: Mass flow controller
1: Flow path (internal flow path)
2: Flow rate sensor part
3: Flow rate control valve
6: Calculation part
7: Opening level control signal output part

1. A mass flow controller comprising:
a flow rate sensor part configured to measure a flow rate of fluid that flows through a flow path, and configured to output a flow rate measurement signal that indicates a value of the flow rate measurement;
a flow rate control valve configured to be provided on an upstream side or a downstream side of the flow rate sensor part;
a calculation part configured to perform at least a proportional calculation on a deviation between a flow rate measurement value indicated by the flow rate measurement signal and a flow rate setting value that is a target value, and configured to calculate a feedback control value for the flow rate control valve; and
an opening level control signal output part configured to generate an opening level control signal on a basis of the feedback control value to output the opening level control signal to the flow rate control valve, wherein:
as a gain value that is multiplied by the deviation in the proportional calculation, a value obtained by substituting the flow rate setting value into a predetermined function is used; and
in a decrease change period that is a predetermined period after a time point when the flow rate setting value decreases by a predetermined amount or more, the predetermined function is a function that is substituted with a calculation value obtained by using a variation between a flow rate setting value before the decrease and a flow rate setting value after the decrease and calculates a larger value as the calculation value decreases.

2. The mass flow controller according to claim 1, wherein
in an increase change period that is a predetermined period after a time point when the flow rate setting value increases by a predetermined amount or more, the predetermined function used for the increase change period is a function that calculates a larger value as the flow rate setting value to be substituted decreases.

3. The mass flow controller according to claim 2, wherein
the increase change period or the decrease change period are adapted to be ended at a time point when the deviation between the flow rate measurement value and the flow rate setting value falls within a certain range.

4. A flow rate control program used for a mass flow controller comprising a flow rate sensor part configured to measure a flow rate of fluid that flows through a flow path and configured to output a flow rate measurement signal that indicates a value of the flow rate measurement, and a flow rate control valve configured to be provided on an upstream side or a downstream side of the flow rate sensor part, the flow rate control program providing a computer with functions as:
a calculation part configured to perform at least a proportional operation on a deviation between a flow rate measurement value indicated by the flow rate measurement signal and a flow rate setting value that is a target value, and configured to calculate a feedback control value for the flow rate control valve; and
an opening level control signal output part configured to generate an opening level control signal on a basis of the feedback control value, and configured to output the opening level control signal to the flow rate control valve, wherein
as a gain value that is multiplied by the deviation in the proportional calculation, the calculation part uses a value obtained by substituting the flow rate setting value into a predetermined function; and
in a decrease change period that is a predetermined period after a time point when the flow rate setting value decreases by a predetermined amount or more, the predetermined function is a function that is substituted with a calculation value obtained by using a variation between a flow rate setting value before the decrease and a flow rate setting value after the decrease and calculates a larger value as the calculation value decreases.
